(19) United States
(12) Patent Application Publication
(10) Pub. No.: US 2018/0007844 A1
(43) Pub. Date: Jan. 11, 2018

(54) HANGER FOR HORTICULTURAL CONTAINER

(71) Applicant: THE HC COMPANIES, INC., Twinsburg, OH (US)

(72) Inventor: Doug Pettigrew, Wilsonville (CA)

(21) Appl. No.: 15/645,514

(22) Filed: Jul. 10, 2017

Related U.S. Application Data
(60) Provisional application No. 62/360,402, filed on Jul. 10, 2016.

(51) Int. Cl. A01G 9/12; A01G 9/02; F16B 2/22; F16M 13/02

(52) U.S. Cl. CPC A01G 9/12; F16M 13/022; A01G 9/02; F16B 2/22

(57) ABSTRACT

Provided is a hanger assembly for a horticultural container. The hanger assembly includes a hook, a plurality of strands extending from the hook, and a clip extending from each strand. Each clip has a retaining leg and a spring leg opposite the retaining leg, where the spring leg and retaining leg are non-mirror images of one another and the spring leg is free of a catch. One of clips is a guide clip and the others of the plurality of clips are secondary clips that are mirror images of the guide clip.

### RELATED APPLICATIONS

This application claims the benefit of U.S. Provisional Application No. 62/360,402 filed Jul. 10, 2016, which is hereby incorporated herein by reference.

### FIELD OF INVENTION

The present invention relates generally to a hanger, and more particularly to a hanger for horticultural containers.

### BACKGROUND

Plants are often sold in pre-planted arrangements in planters and hanging baskets. The identification of the type or types of plants in a container, care or growing instructions, and pricing information may be printed on a tag that is hung from a tag slot in the container. The slot may be present in the upper rim of the container and a portion of the tag is inserted upwardly through the slot such that the main body of the tag with the printed information hangs adjacent the sidewall of the container.

During display for sale, the planter, which rests on its bottom surface, may be oriented so that the tag faces the point of view of consumers. Hanging baskets, on the other hand, when displayed from a hanging position, are typically oriented in one of two orientations depending on how a hanger interacts with a supporting member. For example, a hanging basket may be supported by a pole using a conventional hanger assembly. The hanger assembly has a hook that follows a major plane thereof and orients itself relative to the pole such that the major plane is perpendicular to the longitudinal axis of the pole. As a result, the region of the hanging basket that is in the major plane and adjacent the open side of the hook will face radially outward from the longitudinal axis of the pole. This might face a customer that is browsing hanging basket inventory or might face away from the customer depending on whether the open side of the hook faces where the customer might stand or faces away from where the customer might stand. Depending on where the tag slot and associated tag are positioned relative to the orientation of the hanger assembly and the amount of crowding of hanging baskets on a display pole, the tag may not be readily visible to the customer.

FIG. 1 shows a conventional hanger assembly 110 attached to a hanging basket 112. Clips 114 are positioned at the lower ends of stands that, at their upper ends, connect to the hook. The illustrated example shows a hanger with four stands and clips. FIG. 2 shows an enlarged side view of one of the clips. In the illustrated example, an upper rim of the hanging basket has a horizontal portion that extends radially from the upper end of the sidewall of the basket and a downwardly projecting portion that is generally concentric with the sidewall of the basket. Therefore, when taken with an upper end of the sidewall, the upper rim forms an inverted, flat-bottomed U-shaped structure. As illustrated, the clips are symmetrical. One side of the clip rests against the interior surface of the sidewall of the basket and a catch element of the clip does not otherwise interact with the basket. The other side of the clip interacts with the upper rim of the basket. This side of the clip is positioned radially outward from the downwardly projecting portion and the catch element of this side of the clip hooks under the lower edge of the downwardly projecting portion to trap the upper rim in the clip and bear the load of the hanging basket when hung by the hanging assembly.

The orientation of the major plane of the hook portion of the hanger assembly relative to the hanging basket will depend on a number of factors and the permutations derivable from the factors. The factors include the number of stands/clips, the side of each clip facing inward and facing outward because the clips are symmetrical, which leg of the clip is on the inside of the container and which leg is on the outside of the container, and which strand is clipped to which location of the upper rim.

### SUMMARY OF INVENTION

The present application provides a hanger assembly for a horticultural container. The hanger assembly includes a hook, a plurality of strands extending from the hook, and a clip extending from each strand. Each clip has a retaining leg and a spring leg opposite the retaining leg, where the spring leg and retaining leg are non-mirror images of one another and the spring leg is free of a catch. One of the clips is a guide clip and the others of the plurality of clips are secondary clips that are mirror images of the guide clip.

In an embodiment, a hanger assembly attachable to a horticultural container is provided. The assembly includes a hook, two or more strands extending from the hook, and a clip extending from each of the strands, wherein each clip has a retaining leg terminated by a catch for engaging with an outer lip of the horticultural container to support a load of the container and a spring leg free of a catch that extends toward the retaining leg, the spring leg configured to abut an inner surface of the horticultural container and apply a force against the inner surface to retain the retaining leg in position when the load is not applied.

In another embodiment, a hanger assembly attachable to a horticultural container is provided. The assembly includes a hook following a major plane thereof and configured to be hung on a pole such that the major plane is perpendicular to a longitudinal axis of the pole when hung thereon, two or more strands extending downwardly from the hook, and a clip extending downwardly from each of the strands, wherein each clip is a substantially inverted U-shape having a curved portion extending from the respective strand and a pair of legs extending from opposite ends of the curved portion, and wherein one of the legs of each clip is a retaining leg terminated by an inwardly and upwardly projecting catch and one of the legs of each clip is a spring leg having an inwardly bent portion bent toward the retaining leg and an outwardly bent portion extending from the inwardly bent portion and bent away from the catch.

In still another embodiment, a hanger assembly attachable to a horticultural container is provided. The assembly includes a hook, a plurality of strands extending from the hook, a guide clip extending from one of the strands and having a retaining leg and a spring leg opposite the retaining leg, wherein the spring leg and retaining leg are non-mirror images of one another, and two or more secondary clips extending from respective ones of the plurality of strands, wherein each secondary clip is a mirror image of the guide clip.

The foregoing and other features of the application are described below with reference to the drawings.

### BRIEF DESCRIPTION OF THE DRAWINGS

FIG. 1 is a perspective view of a conventional container and hanger assembly.

FIG. 2 is a side view of a clip of the assembly of FIG. 1.

FIG. 3 is a perspective view of an exemplary horticultural container.

FIG. 4 is a front view of the horticultural container with a tag in a tag slot.

FIG. 5 is a side view of an exemplary hanger assembly for attachment to the horticultural container of FIG. 4.

FIG. 6 is a perspective view of the hanger assembly.

FIG. 7 is a top view of the hanger assembly.

FIG. 8 is a bottom view of the hanger assembly.

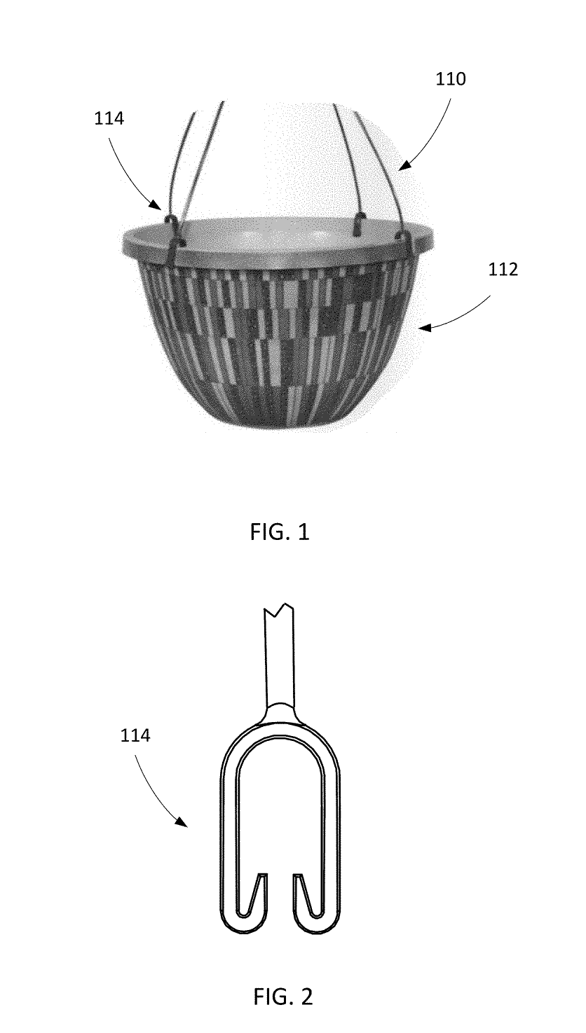

### DETAILED DESCRIPTION

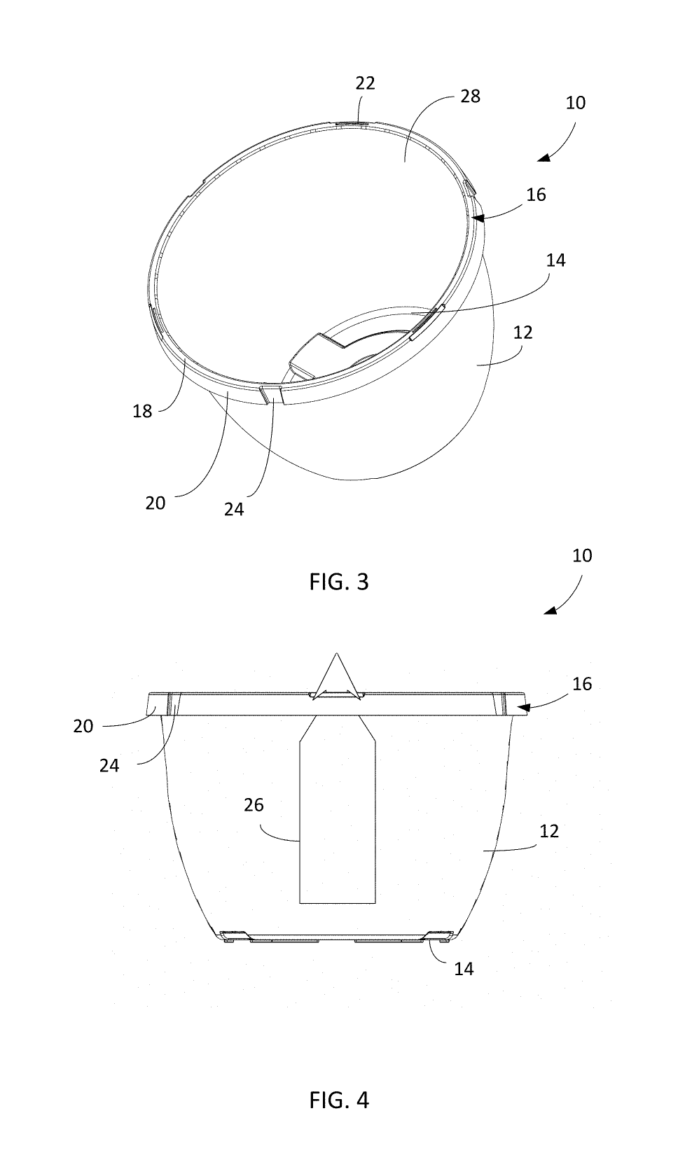

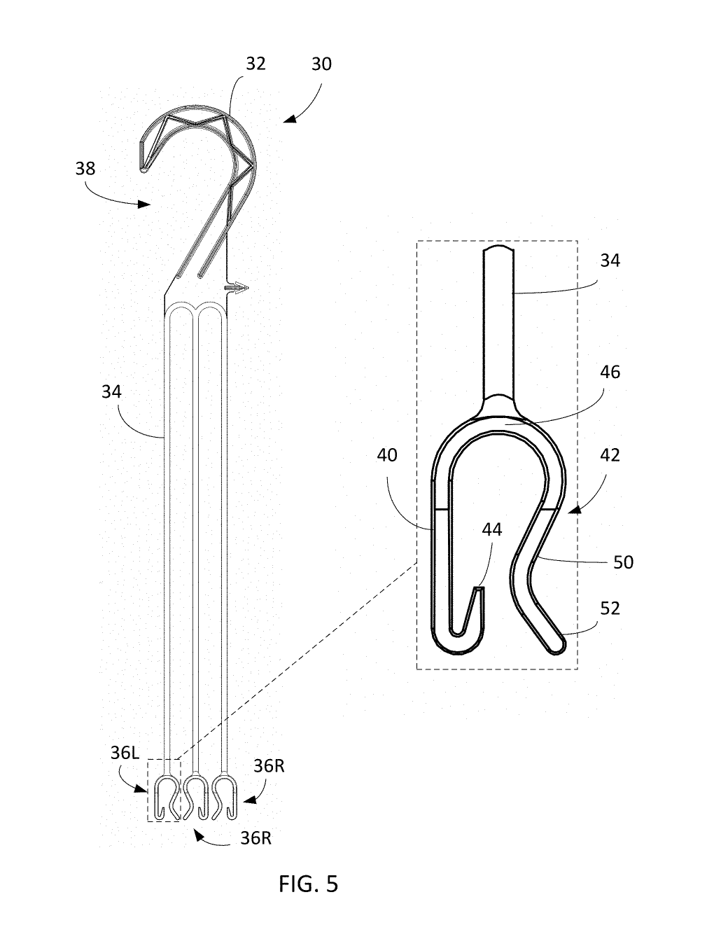

Turning now to FIGS. 3 and 4, an exemplary horticultural container is shown at reference numerals 10. The horticultural container 10 includes a conical sidewall 12, a base 14 attached to a bottom of the conical wall, and an upper rim 16 extending from a top of the conical wall. The upper rim 16 has a horizontal portion 18 that extends radially from an upper end of the sidewall 12 and a downwardly projecting portion 20 that extends downwardly from an outer edge of the horizontal portion 18 generally concentric with the sidewall 12 thereby forming with the upper end of the sidewall 12 an inverted, flat-bottomed substantially U-shaped structure. The upper rim 16 includes one or more tag slots 22, and in the illustrated embodiment three tag slots, and a plurality of receiving locations 24, and in the illustrated embodiment three receiving locations. The tag slots 22 and receiving locations 24 may have any suitable spacing around the upper rim 16, for example, the tag slots 22 may be interposed between each pair of receiving locations 24 circumferentially spaced around the upper rim 16. It will be appreciated that any suitable number of tag slots and receiving locations may be provided.

The tag slots 22 are provided for receiving a tag 26 that, for example, provides identification and/or one or more pictures of the plant in the horticultural container 10, and the receiving locations 24 are provided for receiving a hanger assembly 30 as will be discussed in detail below. The receiving locations 24 may have a reduced radial thickness to the horizontal portion 18 of the upper rim 16 to facilitate interaction of the hanger assembly 30 with the upper rim 16. As shown, the receiving locations 24 extend through the downwardly projecting portion 20 toward the horizontal portion 18.

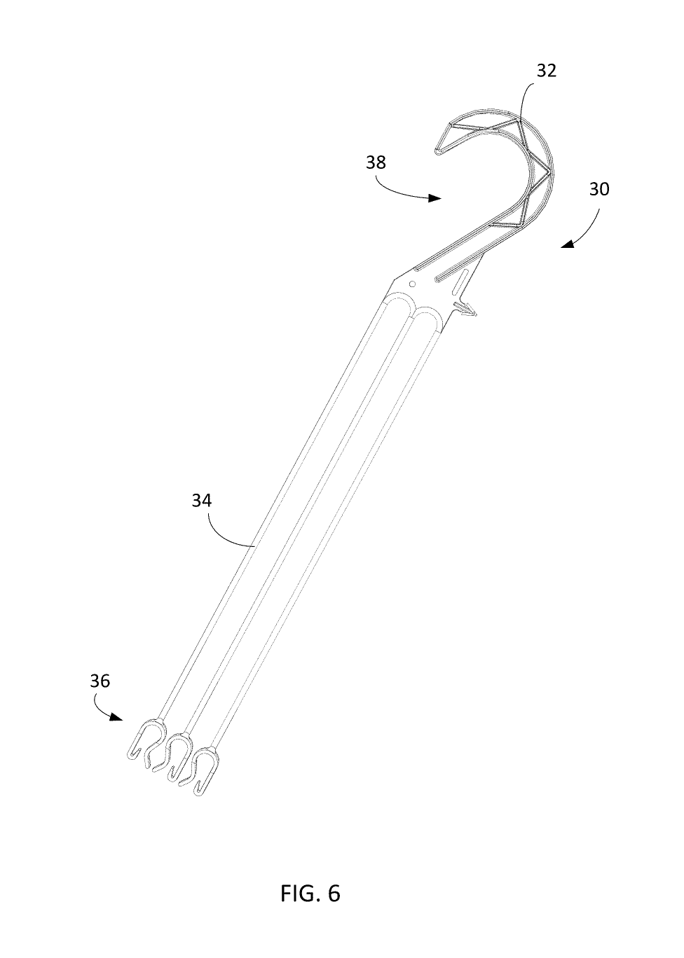

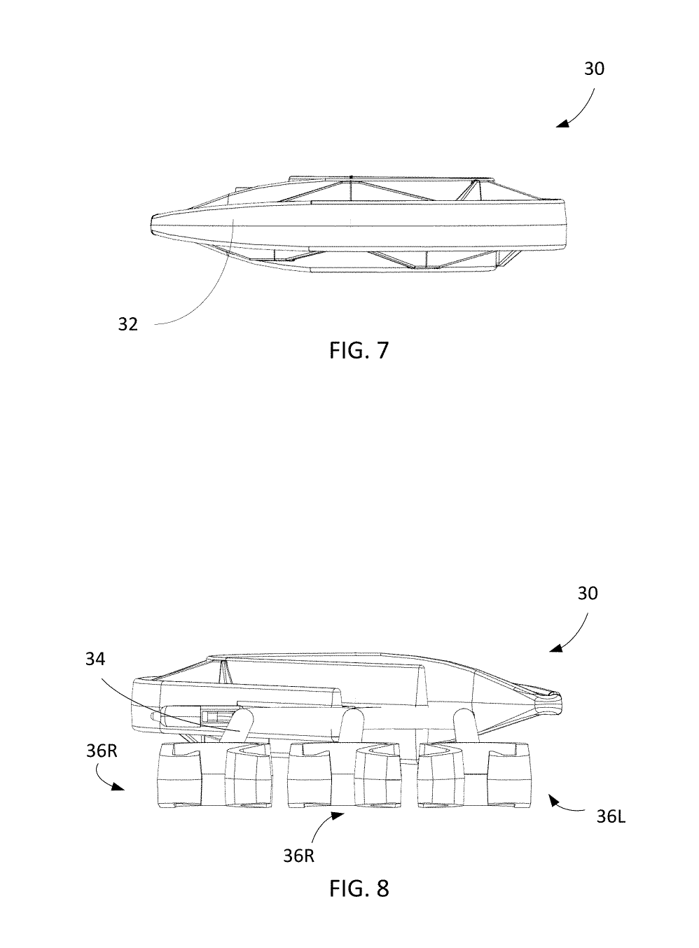

Turning now to FIGS. 5-8, the hanger assembly 30 includes a hook 32, a plurality of strands 34 extending from the hook 32, and in the illustrated embodiment three strands, and a clip 36 extending from each strand 34. The hook 32 follows a major plane thereof and is configured to be hung on a pole such that the major plane is perpendicular to a longitudinal axis of the pole when hung thereon. The plurality of strands 34 extend downwardly from the hook 32 and the clips 36 extend downwardly from the strands 34 such that the strands 34 and clips 36 are in the major plane of the hook when unattached to the container 10. As shown, the hook, strands, and clips are unitarily formed, for example by molding, but may be formed in any suitable manner. In the illustrated embodiment, the strands 34 are substantially the same length as one another and the clips 36 are substantially the same length as one another such that the bottoms of the clips 36 are in the same plane.

Referring now to the clips 36 in detail, the enlarged clip 36 shown in FIG. 5 is a guide clip or left-hand clip designated with reference numeral 36L. The remaining clips 36 are secondary clips or right-hand clips that are mirror images of the guide clip 36L and are designated by reference numeral 36R. The hanger assembly 30 includes one guide clip 36L and the remaining clips are secondary clips 36R. For example, the assembly 30 may include one guide clip 36L and two secondary clips 36R, one guide clip 36L and three secondary clips 36R, etc. By providing the single guide clip 36L and the plural retaining clips 36R, the location of the major plane of the hook 32 is limited with respect to the container 10 and a direction of an opening 38 of the hook 32 is limited. The major plane of the hook will generally cross through one of the tag slots 22 with the opening 38 of the hook 32 facing away from that tag slot 22, thereby providing the tag slot 22 away from the opening 38 to receive the tag 26 such that when the container 10 is hung in a merchandizing environment, due to the natural tendency of persons to hang horticultural containers with the hook opening away from the person carrying out the hanging, the tag 26 has the highest probability of facing the customer. In this way, the tags in each of a plurality of containers can be reliability placed in the same location as in other containers when the tag is installed before reaching a point of sale, such that the tags are in the same orientation as one another when the hooks are hung on a pole at the point of sale.

The guide clip 36L and the secondary clips 36R each include a retaining leg 40 and a spring leg 42 that are asymmetrical non-mirror images of one another about a vertical axis extending between the legs and through the respective strand 34. Each retaining leg 40 is terminated by a catch 44 for engaging with the downwardly projecting portion 20 of the upper rim 16 at one of the receiving locations 24 to support a load of the container 10, and each spring leg 42 is resilient for abutting an inner surface 28 of the horticultural container 10 and applying a force against the inner surface 28 to retain the retaining leg 40 in position when the load is not applied. In an embodiment, the clips 36 each are a substantially inverted U-shape having a curved portion 46 extending from one of the strands 34, and the retaining leg 40 and the spring leg 42 extend from opposite ends of the curved portion 46 spaced apart from one another.

Each retaining leg 40 is terminated by the catch 44 such that when the respective clip is installed on the upper rim 16 at the receiving location 24, the retaining leg 40 is positioned to the outside of the container 10 and the catch 44 surrounds the downwardly projecting portion 20. The catch 44 extends inwardly from the retaining leg 40 and upwardly from a bottom of the retaining leg 40 such that the retaining leg is substantially J-shaped or a mirror image thereof. As shown, the retaining leg 40 would be radially outward from the downwardly projecting portion 20 and the catch 44 would hook under a lower edge of the downwardly projecting portion 20 to trap the upper rim 16 in the clip and bear the load of the container 10 when hung by the hanger assembly 30.

Each spring leg 44 is free of a catch and includes an inwardly bent portion 50 bent toward the retaining leg 40 and an outwardly bent portion 52 extending from the inwardly bent portion 50 and bent away from the catch 44. The inwardly and outwardly bent portions 50 and 52 form a thumb catch for an installer to place her thumb on during installation for ease of installation. In the illustrated embodiment, when unattached to the container 10, the separation between the inwardly bent portion 50 and the catch 44 may be less than the thickness of the receiving location 24 of the upper rim 16.

When installed on the upper rim 16, the spring leg 42 is radially inward of the horizontal portion 18 and rests against the interior surface 28 of the container 10. Resilience of the spring leg 42 provides a leaf spring-like force against the container 10 to retain the retaining leg 40 in its engaged position with the upper rim 16 even in the absence of tension on the strand 34 by hanging of the container 10. That is, the counter-biasing spring-like force from the spring leg 42 prevents the clip 36 from sliding slightly downward relative to the upper rim 16 and freeing itself when there is no tension on the strand 34.

To assist in identifying the appropriate tag slot 22 to receive the tag 26 to the person inserting the tag, the hook assembly may include an arrow 60, marking, and/or indicia extending from a side of the hook 32 opposite the opening 38 that points in the direction of the appropriate tag slot. It will be appreciated that the arrow 60, marking, and/or indicia may be located on any suitable part of the side of the hook 32 opposite the opening.

To install the hanger assembly 30 onto the container 10, each of the clips 36 are placed over one of the receiving locations 24 so that the outwardly bent portions 52 of the spring legs 42 and the catches 44 of the retaining legs 40 straddle the respective receiving location with the spring legs 42 being radially inward of the upper rim 16 and the retaining legs 40 being radially outward of the upper rim 16. Downward force is then applied to the clips 36 thereby causing the spring legs 42 and/or the retaining legs 40 to resiliently flex apart from one another, allowing the clips 36 to travel downwardly relative to the upper rim 16 until the upper rim 16 becomes trapped between the respective retaining legs 40 and spring legs 42 and above the curved portion of the retaining legs terminating at the catches 44. Once this relationship is achieved, the retaining legs 40 and spring legs 42 may return toward their original positions, which may be limited by the thickness of the upper rim 16 at the receiving locations 24, which allows the catches 44 to hook on the downwardly projecting portions 20 of the upper rim 16. The tag 26 may then be installed in the tag slot 24 in-between the secondary clips 36R to which the arrow 60 points allowing the tag 26 to be reliably positioned at a consumer-facing portion of the container 10 when hung for display at a retail location.

Due to the absence of a catch on the spring legs 42, the clips 36 will be oriented as described for proper attachment to the container 10 and without twisting of the strands 34, thereby reducing permutations of how the hanger assembly 30 may be attached to the container 10. Additionally, the orientation of the guide clips 36L and secondary clips 36L reduce permutations of the location of the tag 26 relative to the major plane of the hook 32 while maintaining usability with containers having different upper rim thicknesses and with or without tag slots.

Although certain embodiments have been shown and described, it is understood that equivalents and modifications falling within the scope of the appended claims will occur to others who are skilled in the art upon the reading and understanding of this specification.

What is claimed is:

1. A hanger assembly attachable to a horticultural container, the assembly comprising:
a hook;
two or more strands extending from the hook; and
a clip extending from each of the strands, wherein each clip has a retaining leg terminated by a catch for engaging with an outer lip of the horticultural container to support a load of the container and a spring leg free of a catch that extends toward the retaining leg, the spring leg configured to abut an inner surface of the horticultural container and apply a force against the inner surface to retain the retaining leg in position when the load is not applied.

2. The hanger according to claim 1, wherein each spring leg has an inwardly bent portion bent toward the respective retaining leg and an outwardly bent portion extending from the inwardly bent portion and bent away from the retaining leg.

3. The hanger assembly according to claim 1, wherein the two or more strands include one strand with the clip extending therefrom being a guide clip and at least one strand with the clip extending therefrom being a secondary clip that is a mirror image of the guide clip.

4. The hanger according to claim 1, wherein each catch extends inwardly and projects upwardly such that the retaining legs are substantially J-shaped.

5. The hanger assembly according to claim 4, wherein the at least one strand with the secondary clip includes two or more strands each having one of the secondary clips extending therefrom.

6. The hanger assembly according to claim 1, wherein one of the two or more clips is a guide clip with the retaining leg on a first side and the spring leg on a second side, and wherein one of the two or more clips is a secondary clip that is a mirror image of the guide clip such that the retaining leg of the secondary clip is on a second side and the spring leg is on a first side.

7. The hanger assembly according to claim 1, wherein each clip is a substantially inverted U-shape having a curved portion extending from the respective strand and the respective retaining leg and spring leg extending from opposite ends of the curved portion.

8. The hanger assembly according to claim 1, wherein the hook has a first side defining an opening for hanging and a second side opposite the first side, and wherein the hook includes an arrow extending from the second side in a direction away from the first and second sides.

9. The hanger assembly according to claim 1 in combination with the horticultural container, wherein the clips engage the outer lip of the horticultural container at circumferentially spaced receiving locations.

10. The combination according to claim 9, wherein the hook has a first side defining an opening for hanging and a second side opposite the first side, wherein the hook includes an arrow extending from the second side in a direction away from the first and second sides, and wherein the arrow points towards a tag slot in the outer lip of the horticultural container interposed between two of the receiving locations.

11. A hanger assembly attachable to a horticultural container, the assembly comprising:
a hook following a major plane thereof and configured to be hung on a pole such that the major plane is perpendicular to a longitudinal axis of the pole when hung thereon;
two or more strands extending downwardly from the hook; and
a clip extending downwardly from each of the strands, wherein each clip is a substantially inverted U-shape having a curved portion extending from the respective strand and a pair of legs extending from opposite ends of the curved portion, and wherein one of the legs of each clip is a retaining leg terminated by an inwardly and upwardly projecting catch and one of the legs of each clip is a spring leg having an inwardly bent portion bent toward the retaining leg and an outwardly bent portion extending from the inwardly bent portion and bent away from the catch.

12. The hanger assembly according to claim 11, wherein the two or more strands and the respective clips are in the major plane when unattached to a horticultural container.

13. The hanger assembly according to claim 11, wherein each of the spring legs is free of a catch.

14. The hanger assembly according to claim 11, wherein each catch extends inwardly and projects upwardly such that the respective retaining leg is substantially J-shaped.

15. The hanger assembly according to claim 11, wherein the two or more strands include one strand with the clip extending therefrom being a guide clip and at least one strand with the clip extending therefrom being a secondary clip that is a mirror image of the guide clip.

16. The hanger assembly according to claim 15, wherein the at least one strand with the secondary clip includes two or more strands each having one of the secondary clips extending therefrom.

17. The hanger assembly according to claim 11, wherein one of the two or more clips is a guide clip with the retaining leg on a first side and the spring leg on a second side, and wherein one of the two or more clips is a secondary clip that is a mirror image of the guide clip such that the retaining leg of the secondary clip is on a second side and the spring leg is on a first side.

18. The hanger assembly according to claim 11, wherein the hook has a first side defining an opening for hanging and a second side opposite the first side, and wherein the hook includes an arrow extending from the second side in a direction away from the first and second sides.

19. A hanger assembly attachable to a horticultural container, the assembly comprising:
a hook;
a plurality of strands extending from the hook;
a guide clip extending from one of the strands and having a retaining leg and a spring leg opposite the retaining leg, wherein the spring leg and retaining leg are non-mirror images of one another; and
two or more secondary clips extending from respective ones of the plurality of strands, wherein each secondary clip is a mirror image of the guide clip.

20. The hanger assembly according to claim 19, wherein the retaining leg is terminated by a catch for engaging with an outer lip of the container and the spring leg is free of a catch and configured to abut an inner surface of the container.
